(19) United States
(12) Patent Application Publication
(10) Pub. No.: US 2026/0266638 A1
(43) Pub. Date: Sep. 10, 2026

(54) MEASUREMENT APPARATUS

(71) Applicant: Yokogawa Electric Corporation, Musashino-shi, Tokyo (JP)

(72) Inventors: Ken-ichi Hino, Musashino-shi, Tokyo (JP); Tsutomu Suzuki, Musashino-shi, Tokyo (JP); Rui Zhou, Musashino-shi, Tokyo (JP); Atsushi Yumoto, Musashino-shi, Tokyo (JP); Youhei Kamiya, Musashino-shi, Tokyo (JP)

(73) Assignee: Yokogawa Electric Corporation, Musashino-shi, Tokyo (JP)

(21) Appl. No.: 19/166,553

(22) PCT Filed: Feb. 22, 2024
(86) PCT No.: PCT/JP2024/006604

§ 371 Date: Sep. 18, 2025

(30) Foreign Application Priority Data
Mar. 22, 2023 (JP) 2023-045953

(51) Int. Cl. G01F 1/38; G01F 15/02; G01F 15/063; G01L 9/00

(52) U.S. Cl. CPC G01F 1/383; G01F 15/024; G01F 15/063; G01L 9/0016; G01L 9/0041

(57) ABSTRACT

A measurement apparatus 1 according to the present disclosure is a measurement apparatus 1 for contributing to measurement of a flow rate of a fluid flowing in a flow channel F, the measurement apparatus 1 including a plurality of pressure sensors 10 respectively arranged at a plurality of locations in the flow channel F, a single reference power supply 20 configured to provide a common voltage reference to each of the pressure sensors 10, a single counter circuit 40 configured to count in common a frequency of an output signal outputted from each of the pressure sensors 10, the frequency being for calculating a pressure of the fluid at a corresponding location, the pressure being associated with the flow rate, and a single excitation source 50 configured to provide a frequency reference to the counter circuit 40.

### CROSS-REFERENCE TO RELATED APPLICATION

The present application claims priority to Japanese Patent Application No. 2023-045953 filed on Mar. 22, 2023, the entire contents of which are incorporated herein by reference.

### TECHNICAL FIELD

The present disclosure relates to a measurement apparatus.

### BACKGROUND

Technology related to a measurement apparatus for measuring the flow rate of a fluid flowing in a flow channel is known. This technology uses a plurality of pressure gauges arranged respectively at a plurality of locations in the flow channel. Such pressure gauges measure the pressure of the fluid at the installation locations based on a sensor element having a diaphragm and an oscillator.

For example, Patent Literature (PTL) 1 discloses an oscillating sensor measurement apparatus that achieves stable oscillation of the oscillator, improved measurement accuracy of a physical quantity by noise removal, and improved yield of oscillators.

### CITATION LIST

### Patent Literature

PTL 1: JP 2010-210371 A

### SUMMARY

### Technical Problem

In conventional measurement apparatuses for measuring the flow rate of a fluid, each of pressure gauges individually has a diaphragm and an oscillator, as described in PTL 1. In addition, each of the pressure gauges also individually includes a reference power supply to provide a bias voltage applied between the oscillator and a fixed electrode. Furthermore, each of the pressure gauges also individually has a counter circuit for counting the frequency of the output signal outputted from the sensor element that has the oscillator and an excitation source to provide a frequency reference to the counter circuit. This configuration results in large individual differences in the characteristics of each pressure gauge, thereby reducing the accuracy of flow rate measurement.

It is an aim of the present disclosure to provide a measurement apparatus capable of improving the measurement accuracy of the flow rate of a fluid flowing in a flow channel.

### Solution to Problem

A measurement apparatus according to several embodiments is a measurement apparatus for contributing to measurement of a flow rate of a fluid flowing in a flow channel, the measurement apparatus including a plurality of pressure sensors respectively arranged at a plurality of locations in the flow channel; a single reference power supply configured to provide a common voltage reference to each pressure sensor in the plurality of pressure sensors; a single counter circuit configured to count in common a frequency of an output signal outputted from each pressure sensor in the plurality of pressure sensors, the frequency being for calculating a pressure of the fluid at a corresponding location, the pressure being associated with the flow rate; and a single excitation source configured to provide a frequency reference to the counter circuit.

This configuration can improve the measurement accuracy of the flow rate of a fluid flowing in a flow channel. The measurement apparatus has a single reference power supply, a single counter circuit, and a single excitation source, which can be arranged in common for a plurality of pressure sensors. Therefore, the measurement apparatus enables synchronized simultaneous measurement for each pressure sensor.

In addition, the measurement apparatus can reduce individual differences in the characteristics of each pressure sensor and improve the accuracy of flow rate measurement. For example, by a common reference power supply being arranged for each pressure sensor, the relative accuracy of the output is improved among sensor elements based on the reference power supply. For example, by a common excitation source being arranged for each pressure sensor, the relative quantization error caused by the excitation source is reduced. Furthermore, the long-term stability attributed to the reference power supply and the excitation source is also improved, thereby suppressing a decrease in the relative accuracy as time elapses.

The measurement apparatus can also contribute to a reduction in board space by sharing the electric circuit portion among the plurality of pressure sensors. This facilitates a reduction in size of the measurement system that includes the measurement apparatus.

The measurement apparatus in an embodiment may further include a single arithmetic circuit configured to calculate the pressure of the fluid at the corresponding location based on the frequency counted by the counter circuit.

This enables the measurement apparatus to have the plurality of pressure sensors and the arithmetic circuit arranged within the same apparatus. Therefore, the measurement apparatus can contribute to a reduction in size by reducing the space occupied by the measurement system that includes the measurement apparatus, while enabling synchronized simultaneous measurement for each pressure sensor.

In the measurement apparatus in an embodiment, the arithmetic circuit may be configured to calculate the flow rate based on a pressure difference in the fluid between the plurality of locations. This enables the measurement apparatus to accurately measure the flow rate of the fluid flowing in the flow channel.

The measurement apparatus in an embodiment may further include a communication interface configured to transmit a calculation result from the arithmetic circuit to an external apparatus.

This enables the measurement apparatus to provide the calculation results from the arithmetic circuit as information to an external apparatus as necessary. Therefore, the measurement apparatus can cause the external apparatus to display the calculation results as information and also prompt a user to confirm the information. The measurement apparatus can cause the external apparatus to display measurement parameters, such as each pressure, the pressure difference, and the flow rate, calculated by the arithmetic circuit and prompt the user to confirm the measurement parameters.

In a measurement apparatus in an embodiment, each pressure sensor in the plurality of pressure sensors may include a diaphragm configured to receive the pressure of the fluid and a sensor element configured to output the output signal at the frequency corresponding to the pressure received by the diaphragm.

This enables the measurement apparatus to output, from each of the pressure sensors, an output signal at a frequency corresponding to the pressure received by the diaphragm. The measurement apparatus can thereby calculate the flow rate of the fluid based on the pressure difference in the fluid between the plurality of locations in the flow channel.

In a measurement apparatus in an embodiment, the sensor element may include two oscillators configured to output the output signal and one diode configured to output a voltage proportional to an ambient temperature. This enables the measurement apparatus to receive information, in the arithmetic circuit, on two resonance frequencies and one diode on-voltage and calculate the pressure for each pressure sensor based on Equations (1) to (3), described below.

In a measurement apparatus in an embodiment, the plurality of pressure sensors may include a first pressure sensor and a second pressure sensor, and the single counter circuit may be configured to count in common a first frequency for calculating a first pressure of the fluid at a first location where the first pressure sensor is arranged and a second frequency for calculating a second pressure of the fluid at a second location where the second pressure sensor is arranged. This enables the measurement apparatus to have two pressure sensors in a single apparatus and to measure two pressures simultaneously.

### Advantageous Effect

According to the present disclosure, a measurement apparatus that can improve the measurement accuracy of the flow rate of a fluid flowing in a flow channel can be provided.

### BRIEF DESCRIPTION OF DRAWINGS

In the accompanying drawings:

FIG. 1 is a schematic diagram illustrating an example configuration of a measurement apparatus according to an embodiment of the present disclosure;

FIG. 2 is a block diagram illustrating a more detailed example configuration of the measurement apparatus in FIG. 1;

FIG. 3 is a schematic diagram illustrating an example configuration of a measurement apparatus according to a variation of the present disclosure; and

FIG. 4 is a schematic diagram illustrating a schematic configuration of a conventional measurement system.

### DETAILED DESCRIPTION

The background and problems with conventional technology are described in greater detail.

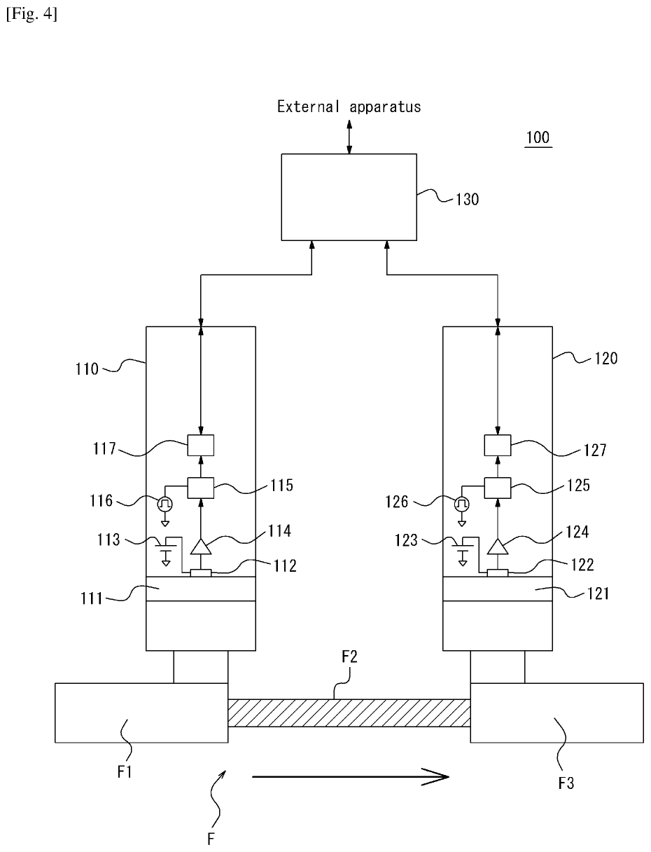

FIG. 4 is a schematic diagram illustrating a schematic configuration of a conventional measurement system 100. The measurement system 100 measures the flow rate of a fluid flowing in a flow channel F. The flow channel F includes a first flow channel F1, a second flow channel F2, and a third flow channel F3. The first flow channel F1, the second flow channel F2, and the third flow channel F3 represent flow channels of fluids such as gases and liquids. The first flow channel F1, the second flow channel F2, and the third flow channel F3 differ from each other in shape and the like. Therefore, the flow channel resistances in these flow channels are different from each other. The second flow channel F2, for example, is a flow channel with a known flow channel resistance, in which fluid flows at a known flow rate when there is a fluid pressure difference at the left and right ends of the second flow channel F2.

The measurement system 100 has a first pressure gauge 110 and a second pressure gauge 120 at both ends of the second flow channel F2 with known flow channel resistance to measure the flow rate of the fluid flowing in the flow channel F. The measurement system 100 measures the pressure difference at both ends of the second flow channel F2 using the first pressure gauge 110 and the second pressure gauge 120. The measurement system 100 measures the flow rate of the fluid flowing in the second flow channel F2 based on the measured pressure difference and the known flow channel resistance of the second flow channel F2.

The measurement system 100 has the two pressure gauges necessary for measuring the flow rate of the fluid arranged at the ends of the second flow channel F2 and calculates the pressure difference between the obtained pressures using a calculator 130, which is arranged separately from the first pressure gauge 110 and the second pressure gauge 120. The measurement system 100 transmits the calculation results obtained by the calculator 130 to a communicably connected external apparatus as necessary.

The first pressure gauge 110 and the second pressure gauge 120 are used to measure the pressure difference between the left and right ends of the second flow channel F2. The first pressure gauge 110 has, in order from the first flow channel F1 side, a diaphragm 111, a sensor element 112, a reference power supply 113, an amplifier 114, a counter circuit 115, an excitation source 116, and an arithmetic circuit 117. The second pressure gauge 120 has, in order from the third flow channel F3 side, a diaphragm 121, a sensor element 122, a reference power supply 123, an amplifier 124, a counter circuit 125, an excitation source 126, and an arithmetic circuit 127.

The diaphragm 111 receives a first pressure P1 of the fluid flowing in the first flow channel F1 and bends at a predetermined tension. The amount of deformation of the diaphragm 111 depends on the first pressure P1. The sensor element 112 outputs, as an output signal, a current with a resonance frequency that depends on the amount of deformation of the diaphragm 111, i.e., that depends on the first pressure P1. The resonance frequency of the current varies according to the change in the first pressure P1 of the fluid flowing in the first flow channel F1.

The reference power supply 113 applies a bias voltage to the sensor element 112 to cause a current having such a resonance frequency to be outputted from the sensor element 112. The amplifier 114 amplifies the output signal from the sensor element 112. The counter circuit 115 counts the resonance frequency of the output signal outputted from the sensor element 112 and amplified by the amplifier 114. The excitation source 116 provides a frequency reference to the counter circuit 115. The arithmetic circuit 117 calculates the first pressure P1 of the fluid flowing in the first flow channel F1 based on the resonance frequency counted by the counter circuit 115.

The first pressure P1 measured by the first pressure gauge 110 as described above is transmitted as information to the higher-level calculator 130 using a communication function of the first pressure gauge 110.

Each configuration included in the second pressure gauge 120 has the same function as the corresponding configuration included in the first pressure gauge 110. The aforementioned method for using the first pressure gauge 110 to measure the first pressure P1 of the fluid flowing in the first flow channel F1 is equally applicable when using the second pressure gauge 120 to measure a second pressure P2 of the fluid flowing in the third flow channel F3.

However, in the conventional measurement system 100, the first pressure gauge 110 and the second pressure gauge 120 are independent of each other. Consequently, the accuracy of flow rate measurement is reduced due to individual differences in the characteristics of each pressure gauge. It is difficult to make the characteristics of the first pressure gauge 110 and the second pressure gauge 120 completely identical, and differences in the characteristics inevitably occur. For example, in each pressure gauge, the reference power supply and the excitation source are arranged separately. This leads to a decrease in the relative accuracy of the output of sensor elements between the first pressure gauge 110 and the second pressure gauge 120 based on the difference in the reference power supply and leads to a significant relative quantization error due to the difference in the excitation source. Long-term stability attributed to these factors is also reduced, resulting in a further decline in relative accuracy as time elapses.

In addition, in the conventional measurement system 100, the higher-level calculator 130 needs to be arranged separately from the first pressure gauge 110 and the second pressure gauge 120 in order to calculate the pressure difference. The first pressure gauge 110 and the second pressure gauge 120 need to be arranged separately, increasing the space occupied by the measurement system 100 overall. A reference power supply, a counter circuit, an excitation source, and an arithmetic circuit, for example, must each be provided for one pressure gauge, which also increases the space occupied by each pressure gauge.

To resolve the above-described problems, it is an aim of the present disclosure to provide a measurement apparatus capable of improving the measurement accuracy of the flow rate of a fluid flowing in a flow channel F.

Embodiments of the present disclosure are mainly described below with reference to the drawings.

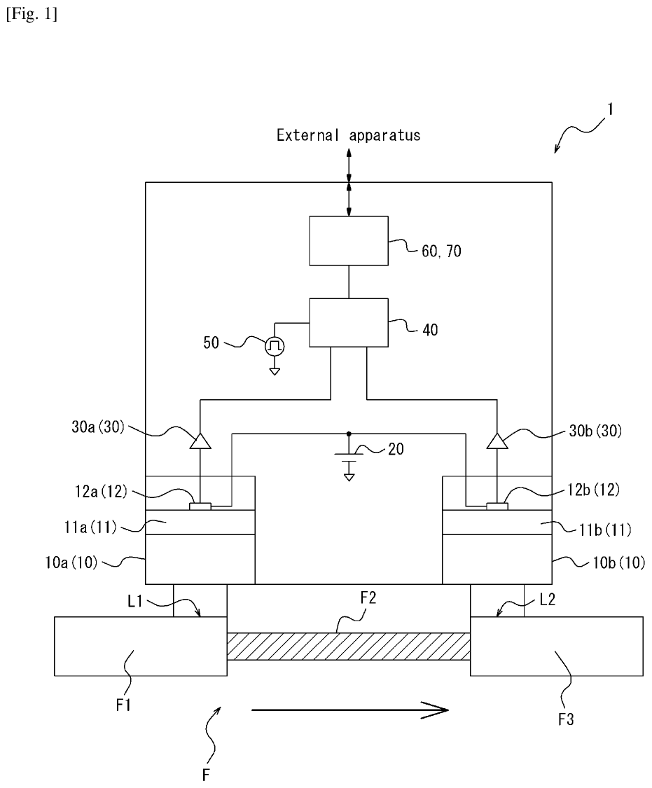

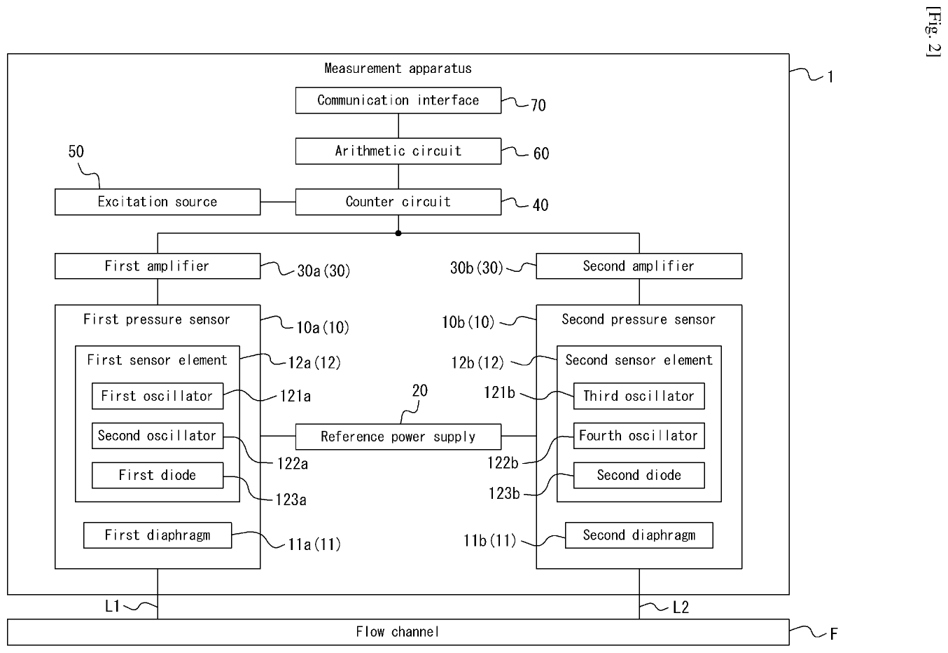

FIG. 1 is a schematic diagram illustrating an example configuration of a measurement apparatus 1 according to an embodiment of the present disclosure. FIG. 2 is a block diagram illustrating a more detailed example configuration of the measurement apparatus 1 in FIG. 1. The configuration of the measurement apparatus 1 according to an embodiment is mainly described with reference to FIG. 1 and FIG. 2.

The measurement apparatus 1 contributes to measurement of the flow rate of a fluid flowing in a flow channel F. The measurement apparatus 1 measures the flow rate of the fluid flowing in the flow channel F. In the present disclosure, the “fluid” includes gases, liquids, and the like. The flow channel F includes a first flow channel F1, a second flow channel F2, and a third flow channel F3. The first flow channel F1, the second flow channel F2, and the third flow channel F3 represent flow channels of the fluid. The first flow channel F1, the second flow channel F2, and the third flow channel F3 differ from each other in shape and the like. Therefore, the flow channel resistances in these flow channels are different from each other. The second flow channel F2, for example, is a flow channel with a known flow channel resistance, in which fluid flows at a known flow rate when there is a fluid pressure difference at the left and right ends of the second flow channel F2. The fluid flows through the interior of the flow channel F in the order of the first flow channel F1, the second flow channel F2, and the third flow channel F3, for example.

The measurement apparatus 1 has a plurality of pressure sensors 10, a single reference power supply 20, a plurality of amplifiers 30, a single counter circuit 40, a single excitation source 50, a single arithmetic circuit 60, and a single communication interface 70. As described below, each of the pressure sensors 10 has a diaphragm 11 that receives the pressure of the fluid and a sensor element 12 that outputs an output signal at a frequency corresponding to the pressure received by the diaphragm 11.

The pressure sensors 10 are respectively arranged at a plurality of locations in the flow channel F. For example, in the measurement apparatus 1, the plurality of pressure sensors 10 includes a first pressure sensor 10a and a second pressure sensor 10b. The first pressure sensor 10a is arranged at a first location L1 in the first flow channel F1, adjacent to one end of the second flow channel F2. The second pressure sensor 10b is arranged at a second location L2 in the third flow channel F3, adjacent to the other end of the second flow channel F2. The first pressure sensor 10a and the second pressure sensor 10b are used to measure the pressure difference between the left and right ends of the second flow channel F2.

The first pressure sensor 10a has, in order from the first flow channel F1 side, a first diaphragm 11a and a first sensor element 12a. The first sensor element 12a has a first oscillator 121a, a second oscillator 122a, and a first diode 123a. The first sensor element 12a has two oscillators that output an output signal, i.e., the first oscillator 121a and the second oscillator 122a.

The first diaphragm 11a receives a first pressure P1 of the fluid flowing in the first flow channel F1 and bends at a predetermined tension. The amount of deformation of the first diaphragm 11a depends on the first pressure P1. The first sensor element 12a outputs, as an output signal, a current with a resonance frequency that depends on the amount of deformation of the first diaphragm 11a, i.e., that depends on the first pressure P1. The resonance frequency of the current varies according to the change in the first pressure P1 of the fluid flowing in the first flow channel F1.

When the first diaphragm 11a receives the first pressure P1 of the fluid flowing in the first flow channel F1 and deforms, the first oscillator 121a of the first sensor element 12a bends according to a first deformation amount of the first diaphragm 11a in the first oscillator 121a. The first oscillator 121a has, for example, a first resonance frequency determined by the shape of its beam. In addition, based on a first bias voltage applied between the first oscillator 121a and the fixed electrode from the reference power supply 20, a first self-excited circuit is formed to vibrate the first oscillator 121a at the first resonance frequency. Therefore, the first oscillator 121a outputs, as an output signal, a first current at the first resonance frequency that depends on the first deformation amount of the first diaphragm 11a, i.e., that depends on the first pressure P1.

When the first diaphragm 11a receives the first pressure P1 of the fluid flowing in the first flow channel F1 and deforms, the second oscillator 122a of the first sensor element 12a bends according to a second deformation amount of the first diaphragm 11a in the second oscillator 122a. The second oscillator 122a has, for example, a second resonance frequency determined by the shape of its beam. In addition, based on a second bias voltage applied between the second oscillator 122a and the fixed electrode from the reference power supply 20, a second self-excited circuit is formed to vibrate the second oscillator 122a at the second resonance frequency. Therefore, the second oscillator 122a outputs, as an output signal, a second current at the second resonance frequency that depends on the second deformation amount of the first diaphragm 11a, i.e., that depends on the first pressure P1.

The first diode 123a in the first sensor element 12a outputs a voltage proportional to the ambient temperature. The first diode 123a housed inside the first sensor element 12a outputs the voltage by passing a constant current. The on-voltage of such a first diode 123a is used as the temperature output of the first sensor element 12a.

The second pressure sensor 10b has, in order from the third flow channel F3 side, a second diaphragm 11b and a second sensor element 12b. The second sensor element 12b has a third oscillator 121b, a fourth oscillator 122b, and a second diode 123b.

The second diaphragm 11b receives a second pressure P2 of the fluid flowing in the third flow channel F3 and bends at a predetermined tension. The amount of deformation of the second diaphragm 11b depends on the second pressure P2. The second sensor element 12b outputs, as an output signal, a current with a resonance frequency that depends on the amount of deformation of the second diaphragm 11b, i.e., that depends on the second pressure P2. The resonance frequency of the current varies according to the change in the second pressure P2 of the fluid flowing in the third flow channel F3.

When the second diaphragm 11b receives the second pressure P2 of the fluid flowing in the third flow channel F3 and deforms, the third oscillator 121b of the second sensor element 12b bends according to a third deformation amount of the second diaphragm 11b in the third oscillator 121b. The third oscillator 121b has, for example, a third resonance frequency determined by the shape of its beam. In addition, based on a third bias voltage applied between the third oscillator 121b and the fixed electrode from the reference power supply 20, a third self-excited circuit is formed to vibrate the third oscillator 121b at the third resonance frequency. Therefore, the third oscillator 121b outputs, as an output signal, a third current at the third resonance frequency that depends on the third deformation amount of the second diaphragm 11b, i.e., that depends on the second pressure P2.

When the second diaphragm 11b receives the second pressure P2 of the fluid flowing in the third flow channel F3 and deforms, the fourth oscillator 122b of the second sensor element 12b bends according to a fourth deformation amount of the second diaphragm 11b in the fourth oscillator 122b. The fourth oscillator 122b has, for example, a fourth resonance frequency determined by the shape of its beam. In addition, based on a fourth bias voltage applied between the fourth oscillator 122b and the fixed electrode from the reference power supply 20, a fourth self-excited circuit is formed to vibrate the fourth oscillator 122b at the fourth resonance frequency. Therefore, the fourth oscillator 122b outputs, as an output signal, a fourth current at the fourth resonance frequency that depends on the fourth deformation amount of the second diaphragm 11b, i.e., that depends on the second pressure P2.

The second diode 123b in the second sensor element 12b outputs a voltage proportional to the ambient temperature. The second diode 123b housed inside the second sensor element 12b outputs the voltage by passing a constant current. The on-voltage of such a second diode 123b is used as the temperature output of the second sensor element 12b.

To cause the corresponding oscillator to output a voltage having a resonance frequency as an output signal, the reference power supply 20 applies a bias voltage to the oscillator. The reference power supply 20 provides a common voltage reference to each of the pressure sensors 10. For example, the reference power supply 20 provides a first voltage reference that serves as the basis for the first bias voltage and the second bias voltage applied respectively to the first oscillator 121a and the second oscillator 122a of the first sensor element 12a. For example, the reference power supply 20 provides a second voltage reference that serves as the basis for the third bias voltage and the fourth bias voltage applied respectively to the third oscillator 121b and the fourth oscillator 122b of the second sensor element 12b. The first voltage reference and the second voltage reference are common to each other.

The plurality of amplifiers 30 amplifies the outputs from the respective plurality of pressure sensors 10. For example, in the measurement apparatus 1, the plurality of amplifiers 30 includes a first amplifier 30a that amplifies the output from the first pressure sensor 10a and a second amplifier 30b that amplifies the output from the second pressure sensor 10b.

The counter circuit 40 counts in common the frequency of the output signal outputted from each of pressure sensors 10. The counter circuit 40 counts the frequency of the output signal based on a clock signal, outputted from the common excitation source 50, that has a higher frequency than the frequency of the output signal. The frequency of the output signal is used to calculate the pressure of the fluid at the corresponding location where the pressure sensor 10 is arranged in the flow channel F. The pressure of the fluid is associated with the flow rate of the fluid.

For example, based on a common clock signal, the counter circuit 40 counts the first resonance frequency based on the first oscillator 121a, the second resonance frequency based on the second oscillator 122a, the third resonance frequency based on the third oscillator 121b, and the fourth resonance frequency based on the fourth oscillator 122b. The counter circuit 40 counts in common the first frequency for calculating the first pressure P1 of the fluid at the first location L1 where the first pressure sensor 10a is arranged and the second frequency for calculating the second pressure P2 of the fluid at the second location L2 where the second pressure sensor 10b is arranged.

In the present disclosure, the “first frequency” includes, for example, the first resonance frequency and the second resonance frequency. The “second frequency” includes, for example, the third resonance frequency and the fourth resonance frequency. The first resonance frequency and the second resonance frequency obtained based on the first pressure sensor 10a are used to calculate the first pressure P1 of the fluid at the first location L1 where the first pressure sensor 10a is arranged in the flow channel F. The third resonance frequency and the fourth resonance frequency obtained based on the second pressure sensor 10b are used to calculate the second pressure P2 of the fluid at the second location L2 where the second pressure sensor 10b is arranged in the flow channel F.

The excitation source 50 provides a frequency reference to the counter circuit 40. The excitation source 50 outputs, to the counter circuit 40, a clock signal that is commonly used to count the first resonance frequency, the second resonance frequency, the third resonance frequency, and the fourth resonance frequency.

The arithmetic circuit 60 includes one or more processors. In the present disclosure, the “processor” is a general purpose processor or a dedicated processor specialized for particular processing, but these examples are not limiting. The arithmetic circuit 60 calculates the pressure of the fluid at the corresponding location based on the frequency counted by the counter circuit 40. The arithmetic circuit 60 is a circuit that performs calculations using software to output the frequency as a pressure indication value.

For example, the arithmetic circuit 60 uses the first resonance frequency and the second resonance frequency counted by the counter circuit 40 and the on-voltage of the first diode 123a outputted from the first diode 123a of the first sensor element 12a to calculate the first pressure P1 of the fluid at the first location L1 where the first pressure sensor 10a is arranged. For example, the arithmetic circuit 60 uses the third resonance frequency and the fourth resonance frequency counted by the counter circuit 40 and the on-voltage of the second diode 123b outputted from the second diode 123b of the second sensor element 12b to calculate the second pressure P2 of the fluid at the second location L2 where the second pressure sensor 10b is arranged.

The arithmetic circuit 60 calculates the flow rate of the fluid based on the pressure difference in the fluid between a plurality of locations. For example, the arithmetic circuit 60 calculates the flow rate of the fluid flowing in the second flow channel F2 based on the difference between the first pressure P1 and the second pressure P2, which is the pressure difference of the fluid between the first location L1 where the first pressure sensor 10a is arranged and the second location L2 where the second pressure sensor 10b is arranged.

The communication interface 70 includes a communication interface that conforms to communication standards based on any appropriate type of wireless or wired communication. Communication standards include wireless LAN (Local Area Network) standards, short-range wireless communication standards, mobile communication standards such as 4G (4^{th} Generation) and 5G (5^{th} Generation), and Internet standards. The measurement apparatus 1 is connected to an information communication network or the like via the communication interface 70. The communication interface 70 transmits, as necessary, the calculation results obtained by the arithmetic circuit 60 to an external apparatus communicably connected to the measurement apparatus 1 via the information communication network.

The measurement apparatus 1 includes the first pressure sensor 10a and the second pressure sensor 10b arranged at both ends of the second flow channel F2, which has a known flow channel resistance, to measure the flow rate of the fluid flowing in the flow channel F. The measurement apparatus 1 measures the pressure difference between the ends of the second flow channel F2 using the first pressure sensor 10a and the second pressure sensor 10b. The measurement apparatus 1 measures the flow rate of the fluid flowing in the second flow channel F2 based on the measured pressure difference and the known flow channel resistance of the second flow channel F2.

In greater detail, the arithmetic circuit 60 of the measurement apparatus 1 calculates the pressures obtained by the two pressure sensors 10, which are respectively arranged at the ends of the second flow channel F2, and the pressure difference between these pressures to calculate the flow rate of the fluid. The arithmetic circuit 60 calculates the pressure P obtained by each pressure sensor 10 based on the following Equations (1) to (7). The pressure P corresponds to the aforementioned first pressure P1 or second pressure P2.

$$P = {\sum }_{i = 0}^{n} {\sum }_{j = 0}^{m} {a}_{ij} {X}^{i} {T}^{j} \qquad ( 1 )$$

$$X = ⌈ {( \frac{{f}_{C}}{{f}_{0 C}} )}^{2} - 1 ⌉ - {A}_{a} ⌈ {( \frac{{f}_{R}}{{f}_{0 R}} )}^{2} - 1 ⌉ \qquad ( 2 )$$

$$T = \frac{{f}_{Ts} - {f}_{0 Ts}}{{f}_{0 Ts}} \qquad ( 3 )$$

$${f}_{C} = α \frac{{H}_{C}}{{L}_{C}^{2}} \sqrt{1 + β {( \frac{{L}_{C}}{{H}_{C}} )}^{2} ( {ε}_{C} + {Δε}_{C} ) - γ \frac{{L}_{C}^{4}}{{d}_{C}^{3} {H}_{C}^{3}} {V}_{CB}^{2}} \qquad ( 4 )$$

$${f}_{R} = α \frac{{H}_{R}}{{L}_{R}^{2}} \sqrt{1 + β {( \frac{{L}_{R}}{{H}_{R}} )}^{2} ( {ε}_{R} + {Δε}_{R} ) - γ \frac{{L}_{R}^{4}}{{d}_{R}^{3} {H}_{R}^{3}} {V}_{RB}^{2}} \qquad ( 5 )$$

$${f}_{0 C} = α \frac{{H}_{C}}{{L}_{C}^{2}} \sqrt{1 + β {( \frac{{L}_{C}}{{H}_{C}} )}^{2} {ε}_{C} - γ \frac{{L}_{C}^{4}}{{d}_{C}^{3} {H}_{C}^{3}} {V}_{CB}^{2}} \qquad ( 6 )$$

$${f}_{0 R} = α \frac{{H}_{R}}{{L}_{R}^{2}} \sqrt{1 + β {( \frac{{L}_{R}}{{H}_{R}} )}^{2} {ε}_{R} - γ \frac{{L}_{R}^{4}}{{d}_{R}^{3} {H}_{R}^{3}} {V}_{RB}^{2}} \qquad ( 7 )$$

As described above, two oscillators are arranged in the sensor element 12 of each pressure sensor 10. The subscript “C” in Equations (1) to (7) is for indicating that the term is a parameter is related to one of the two oscillators. The subscript “R” in Equations (1) to (7) is for indicating that the term is a parameter associated with the other one of the two oscillators.

A description of each parameter included in Equations (1) to (7) is summarized in Table 1 below. The subscript “X” in Table 1 corresponds to the aforementioned “C” or “R”.

TABLE 1

| Parameter | Description |
|---|---|
| f_{X} | Resonance frequency |
| f_{0X} | Resonance frequency in reference state |
| α, β, γ | Constants |
| H_{X} | Thickness of oscillator |
| L_{X} | Length of oscillator |
| d_{X} | Effective gap length of oscillator |
| V_{XB} | Bias voltage |
| εₓ | Tension produced in oscillator in reference state |
| Δε_{X} | Tension produced in oscillator when pressure P is applied |
| f_{Ts} | Diode on-voltage |
| f_{0Ts} | Diode on-voltage in reference state |
| T | Temperature |
| P | Pressure |
| Aₐ | Correction factor |

In the present disclosure, the “reference state” means, for example, a state in which the diaphragm 11 is subjected to a reference pressure of fluid. The “effective gap length” means, for example, the distance between the vibrating beam of the corresponding oscillator and the surface of the fixed electrode opposite the vibrating beam. The “tension produced in the oscillator in the reference state” means, for example, the tensile strain of the vibrating beam.

For example, in a case in which the pressure P corresponds to the first pressure P1, fc corresponds to the first resonance frequency. f_{R} corresponds to the second resonance frequency. f_{0C} corresponds to the first resonance frequency in the reference state. f_{0R} corresponds to the second resonance frequency in the reference state. H_{C}, L_{C}, d_{C}, e_{C}, and De_{C} correspond to parameters associated with the first oscillator 121a. H_{R}, L_{R}, d_{R}, e_{R}, and De_{R} correspond to parameters associated with the second oscillator 122a. V_{CB} corresponds to the first bias voltage. V_{RB} corresponds to the second bias voltage. f_{TS} corresponds to the on-voltage of the first diode 123a. f_{0TS} corresponds to the on-voltage of the first diode 123a in the reference state. T corresponds to the ambient temperature of the first sensor element 12a.

For example, in a case in which the pressure P corresponds to the second pressure P2, fc corresponds to the third resonance frequency. f_{R} corresponds to the fourth resonance frequency. f_{0C} corresponds to the third resonance frequency in the reference state, for corresponds to the fourth resonance frequency in the reference state. H_{C}, L_{C}, d_{C}, e_{C}, and De_{C} correspond to parameters associated with the third oscillator 121b. H_{R}, L_{R}, d_{R}, E_{R}, and De_{R} correspond to parameters associated with the fourth oscillator 122b. V_{CB} corresponds to the third bias voltage. V_{RB} corresponds to the fourth bias voltage. f_{TS} corresponds to the on-voltage of the second diode 123b. f_{0TS} corresponds to the on-voltage of the second diode 123b in the reference state. T corresponds to the ambient temperature of the second sensor element 12b.

In Equation (1), “i” and “j” are used to correct the degree in the pressure P of the parameters X and T, respectively. For example, when pressure is set on the vertical axis and resonance frequency on the horizontal axis, the graph based on Equation (1) does not necessarily change linearly. In order to calculate the pressure P accurately, it is necessary to correct X and T, which are for calculating the pressure P, to predetermined degrees. Therefore, “n” and “m” are defined as appropriate by the user or the like for such correction. aᵢⱼ is the coefficient corresponding to each degree.

According to the measurement apparatus 1 in an embodiment as described above, the measurement accuracy of the flow rate of the fluid flowing in the flow channel F can be improved. The measurement apparatus 1 has the single reference power supply 20, the single counter circuit 40, and the single excitation source 50, which can be arranged in common for the plurality of pressure sensors 10. Therefore, the measurement apparatus 1 enables synchronized simultaneous measurement for each pressure sensor 10.

In addition, the measurement apparatus 1 can reduce individual differences in the characteristics of each pressure sensor 10 and improve the accuracy of flow rate measurement. For example, by a common reference power supply 20 being arranged for each pressure sensor 10, the relative accuracy of the output is improved among sensor elements 12 based on the reference power supply 20. For example, by a common excitation source 50 being arranged for each pressure sensor 10, the relative quantization error caused by the excitation source 50 is reduced. Furthermore, the long-term stability attributed to the reference power supply 20 and the excitation source 50 is also improved, thereby suppressing a decrease in the relative accuracy as time elapses.

The measurement apparatus 1 can also contribute to a reduction in board space by sharing the electric circuit portion among the plurality of pressure sensors 10. This facilitates a reduction in size of the measurement system that includes the measurement apparatus 1.

By further including the single arithmetic circuit 60, the measurement apparatus 1 can have the plurality of pressure sensors 10 and the arithmetic circuit 60 arranged within the same apparatus. The measurement apparatus 1 can thus contribute to a reduction in size by reducing the space occupied by the measurement system that includes the measurement apparatus 1, while enabling synchronized simultaneous measurement for each pressure sensor 10.

The measurement apparatus 1 can accurately measure the flow rate of the fluid flowing in the flow channel F by having the arithmetic circuit 60 calculate the flow rate based on the pressure difference of the fluid.

By further including the communication interface 70 that transmits the calculation results from the arithmetic circuit 60 to an external apparatus, the measurement apparatus 1 can provide the calculation results from the arithmetic circuit as information to an external apparatus as necessary. The measurement apparatus 1 can thus cause the external apparatus to display the calculation result as information and also prompt a user to confirm the information. The measurement apparatus 1 can cause the external apparatus to display measurement parameters, such as each pressure P, the pressure difference, and the flow rate, calculated by the arithmetic circuit 60 and prompt the user to confirm the measurement parameters.

By each of the pressure sensors 10 including the diaphragm 11 and the sensor element 12, the measurement apparatus 1 can output, from each of the pressure sensors 10, an output signal at a frequency corresponding to the pressure P received by the diaphragm 11. The measurement apparatus 1 can thereby calculate the flow rate of the fluid based on the pressure difference in the fluid between the plurality of locations in the flow channel F.

By the sensor element 12 including two oscillators and one diode, the measurement apparatus 1 can receive information, in the arithmetic circuit 60, on two resonance frequencies and one diode on-voltage and calculate the pressure P for each pressure sensor 10 based on the above-described Equations (1) to (3).

The plurality of pressure sensors 10 includes the first pressure sensor 10a and the second pressure sensor 10b. The counter circuit 40 counts in common the first frequency for calculating the first pressure P1 and the second frequency for calculating the second pressure P2. This enables the measurement apparatus 1 to have two pressure sensors 10 in a single apparatus and to measure two pressures P simultaneously.

It will be clear to a person of ordinary skill in the art that the present disclosure may be implemented in certain ways other than the above embodiments without departing from the spirit or essential features thereof. Accordingly, the above explanation merely provides examples that are in no way limiting. The scope of the present disclosure is to be defined by the appended claims, not by the above explanation. Among all changes, various changes that are within the range of equivalents are considered to be included therein.

For example, the shape, size, arrangement, orientation, and number of the above-described components are not limited to the above explanation or the drawings. The shape, size, arrangement, orientation, and number of each component may be selected freely as long as the functions of the component can be achieved. The constituent elements of the measurement apparatus 1 in the drawings are illustrated as functional concepts. The specific form of each constituent element is not limited to the form in the drawings.

In the above embodiment, the measurement apparatus 1 has been described as further including the single arithmetic circuit 60 that calculates the pressure of the fluid at the corresponding location based on the frequency counted by the counter circuit 40, but this configuration is not limiting. The measurement apparatus 1 need not include the arithmetic circuit 60.

In the above embodiment, the arithmetic circuit 60 has been described as calculating the flow rate based on the pressure difference in the fluid between a plurality of locations, but this configuration is not limiting. The arithmetic circuit 60 need not calculate the flow rate. In this case, the measurement apparatus 1 may output only the pressures P and pressure difference of the fluid to an external apparatus as information. The arithmetic circuit 60 may calculate the flow rate based on a different method than the calculation method based on the pressure difference in the fluid between a plurality of locations.

In the above embodiment, the measurement apparatus 1 has been described as further including the communication interface 70 that transmits the calculation results from the arithmetic circuit 60 to an external apparatus, but this configuration is not limiting. The measurement apparatus 1 need not include the communication interface 70. The measurement apparatus 1 may include the arithmetic circuit 60 while not including the communication interface 70, or both the arithmetic circuit 60 and the communication interface 70 may be omitted.

In the above embodiment, each of the pressure sensors 10 has been described as including a diaphragm 11 that receives the pressure of the fluid and a sensor element 12 that outputs an output signal at a frequency corresponding to the pressure received by the diaphragm 11, but this configuration is not limiting. The configuration of the pressure sensor 10 is not limited to the combination of the diaphragm 11 and the sensor element 12 and may be any other configuration capable of measuring the pressure P of the fluid.

In the above embodiment, the sensor element 12 has been described as including two oscillators that output an output signal and one diode that outputs a voltage proportional to the ambient temperature, but this configuration is not limiting. The sensor element 12 may have any other configuration capable of outputting signals necessary for the arithmetic circuit 60 to calculate the pressure P or the flow rate of the fluid.

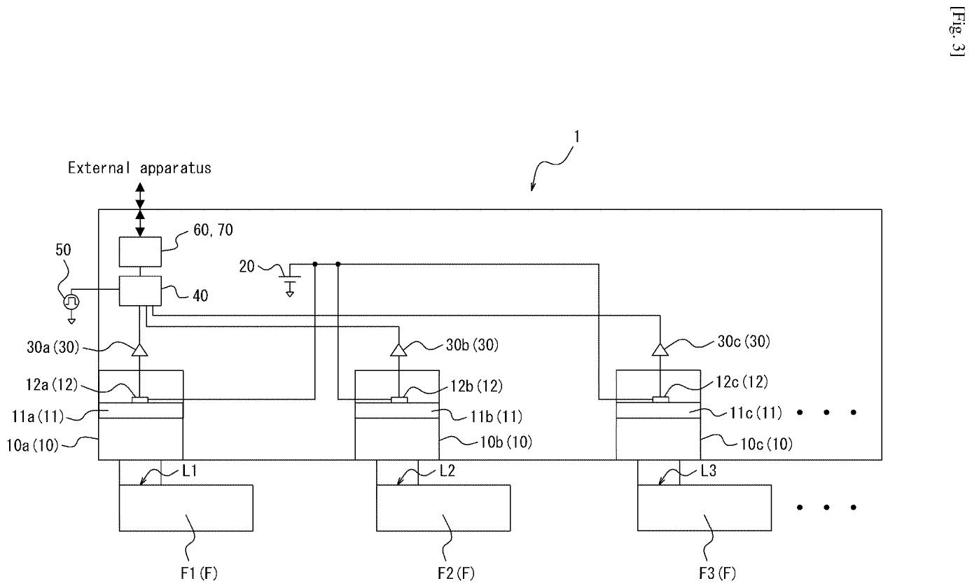

FIG. 3 is a schematic diagram illustrating an example configuration of a measurement apparatus 1 according to a variation of the present disclosure. In the above embodiment, the plurality of pressure sensors 10 has been described as including the first pressure sensor 10a and the second pressure sensor 10b, but this configuration is not limiting. The plurality of pressure sensors 10 may include three or more pressure sensors 10 instead of two. For example, the plurality of pressure sensors 10 may further include a third pressure sensor 10c, for measuring a third pressure P3 of the fluid at a third location L3, in addition to the first pressure sensor 10a and the second pressure sensor 10b.

Accordingly, the plurality of diaphragms 11 may further include a third diaphragm 11c in addition to the first diaphragm 11a and the second diaphragm 11b. The plurality of sensor elements 12 may further include a third sensor element 12c in addition to the first sensor element 12a and the second sensor element 12b. The plurality of amplifiers 30 may further include a third amplifier 30c in addition to the first amplifier 30a and the second amplifier 30b.

In this case, the counter circuit 40 may count in common the first frequency for calculating the first pressure P1 of the fluid at the first location L1 where the first pressure sensor 10a is arranged, the second frequency for calculating the second pressure P2 of the fluid at the second location L2 where the second pressure sensor 10b is arranged, and a third frequency for calculating the third pressure P3 of the fluid at the third location L3 where the third pressure sensor 10c is arranged.

As described above, the measurement apparatus 1 can also be applied to multiple inputs based on the plurality of pressure sensors 10. The measurement apparatus 1 can simultaneously measure the first pressure P1, the second pressure P2, and the third pressure P3 generated respectively in the first flow channel F1, the second flow channel F2, and the third flow channel F3. The measurement apparatus 1 is not limited to two or three inputs but can be configured to have four or more inputs according to the pressures P to be measured.

Even in the above case, the measurement apparatus 1 includes the single reference power supply 20, the single counter circuit 40, and the single excitation source 50 for the plurality of pressure sensors 10. In the measurement apparatus 1, the reference power supply 20 and the excitation source 50 respectively contribute to the relative accuracy and relative quantization error of the output between the sensor elements 12. By sharing the reference power supply 20 and the excitation source 50, which mainly affect the relative accuracy, among the plurality of pressure sensors 10, the measurement apparatus 1 can achieve higher accuracy in the long term compared to a case in which pressure sensors 10 with one input are individually arranged in a plurality of flow channels F. The measurement apparatus 1 achieves the same effect not only with two inputs, as in the above embodiment, but also with an apparatus configured for three or more inputs.

In the above embodiment, the output signal from the sensor element 12 is based on current, but this example is not limiting. The output signal from the sensor element 12 may be based on voltage.

In the system configuration of a pressure sensor that performs simultaneous two-input measurement, for example, the measurement apparatus 1 according to an embodiment of the present disclosure can be used for improving the simultaneous measurement performance, the measurement accuracy, and the long-term stability. For example, the measurement apparatus 1 can be used as a built-in type of compact, highly accurate flow measurement apparatus.

Some embodiments of the present disclosure are exemplified below. It should be noted that the embodiments of the present disclosure are not, however, limited to these examples.
[Appendix 1] A measurement apparatus for contributing to measurement of a flow rate of a fluid flowing in a flow channel, the measurement apparatus comprising:
a plurality of pressure sensors respectively arranged at a plurality of locations in the flow channel;
a single reference power supply configured to provide a common voltage reference to each pressure sensor in the plurality of pressure sensors;
a single counter circuit configured to count in common a frequency of an output signal outputted from each pressure sensor in the plurality of pressure sensors, the frequency being for calculating a pressure of the fluid at a corresponding location, the pressure being associated with the flow rate; and
a single excitation source configured to provide a frequency reference to the counter circuit.
[Appendix 2] The measurement apparatus according to appendix 1, further comprising a single arithmetic circuit configured to calculate the pressure of the fluid at the corresponding location based on the frequency counted by the counter circuit.
[Appendix 3] The measurement apparatus according to appendix 2, wherein the arithmetic circuit is configured to calculate the flow rate based on a pressure difference in the fluid between the plurality of locations.
[Appendix 4] The measurement apparatus according to appendix 2 or 3, further comprising a communication interface configured to transmit a calculation result from the arithmetic circuit to an external apparatus.
[Appendix 5] The measurement apparatus according to any one of appendices 1 to 4, wherein each pressure sensor in the plurality of pressure sensors includes a diaphragm configured to receive the pressure of the fluid and a sensor element configured to output the output signal at the frequency corresponding to the pressure received by the diaphragm.
[Appendix 6] The measurement apparatus according to appendix 5, wherein the sensor element includes two oscillators configured to output the output signal and one diode configured to output a voltage proportional to an ambient temperature.
[Appendix 7] The measurement apparatus according to any one of appendices 1 to 6, wherein
the plurality of pressure sensors includes a first pressure sensor and a second pressure sensor, and
the single counter circuit is configured to count in common a first frequency for calculating a first pressure of the fluid at a first location where the first pressure sensor is arranged and a second frequency for calculating a second pressure of the fluid at a second location where the second pressure sensor is arranged.

### REFERENCE SIGNS LIST

1 Measurement apparatus
10 Pressure sensor
10a First pressure sensor
10b Second pressure sensor
10c Third pressure sensor
11 Diaphragm
11a First diaphragm
11b Second diaphragm
11c Third diaphragm
12 Sensor element
12a First sensor element
121a First oscillator
122a Second oscillator
123a First diode
12b Second sensor element
121b Third oscillator
122b Fourth oscillator
123b Second diode
12c Third sensor element
20 Reference power supply
30 Amplifier
30a First amplifier
30b Second amplifier
30c Third amplifier
40 Counter circuit
50 Excitation source
60 Arithmetic circuit
70 Communication interface
F Flow channel
F1 First flow channel
F2 Second flow channel
F3 Third flow channel
L1 First location
L2 Second location
L3 Third location
P1 First pressure
P2 Second pressure
P3 Third pressure
100 Measurement system
110 First pressure gauge
111 Diaphragm
112 Sensor element
113 Reference power supply
114 Amplifier
115 Counter circuit
116 Excitation source
117 Arithmetic circuit
120 Second pressure gauge
121 Diaphragm
122 Sensor element
123 Reference power supply
124 Amplifier
125 Counter circuit
126 Excitation source
127 Arithmetic circuit
130 Calculator

1. A measurement apparatus for contributing to measurement of a flow rate of a fluid flowing in a flow channel, the measurement apparatus comprising:
a plurality of pressure sensors respectively arranged at a plurality of locations in the flow channel;
a single reference power supply configured to provide a common voltage reference to each pressure sensor in the plurality of pressure sensors;
a single counter circuit configured to count in common a frequency of an output signal outputted from each pressure sensor in the plurality of pressure sensors, the frequency being for calculating a pressure of the fluid at a corresponding location, the pressure being associated with the flow rate; and
a single excitation source configured to provide a frequency reference to the counter circuit.

2. The measurement apparatus according to claim 1, further comprising a single arithmetic circuit configured to calculate the pressure of the fluid at the corresponding location based on the frequency counted by the counter circuit.

3. The measurement apparatus according to claim 2, wherein the arithmetic circuit is configured to calculate the flow rate based on a pressure difference in the fluid between the plurality of locations.

4. The measurement apparatus according to claim 2, further comprising a communication interface configured to transmit a calculation result from the arithmetic circuit to an external apparatus.

5. The measurement apparatus according to claim 1, wherein each pressure sensor in the plurality of pressure sensors includes a diaphragm configured to receive the pressure of the fluid and a sensor element configured to output the output signal at the frequency corresponding to the pressure received by the diaphragm.

6. The measurement apparatus according to claim 5, wherein the sensor element includes two oscillators configured to output the output signal and one diode configured to output a voltage proportional to an ambient temperature.

7. The measurement apparatus according to claim 1, wherein
the plurality of pressure sensors includes a first pressure sensor and a second pressure sensor, and
the single counter circuit is configured to count in common a first frequency for calculating a first pressure of the fluid at a first location where the first pressure sensor is arranged and a second frequency for calculating a second pressure of the fluid at a second location where the second pressure sensor is arranged.
